(19) United States
(12) Patent Application Publication
(10) Pub. No.: US 2017/0180850 A1
(43) Pub. Date: Jun. 22, 2017

(54) WATERPROOF ELECTRONIC DEVICE WITH PRESSURE-EQUILIBRIUM FUNCTIONS

(71) Applicant: Quanta Computer Inc., Taoyuan City (TW)

(72) Inventors: Chia-Ju HSU, Taoyuan City (TW); Yu-Liang CHEN, Taoyuan City (TW); Ko-Chun WANG, Taoyuan City (TW); Chun-Nan HUANG, Taoyuan City (TW); Zih-Yun WANG, Taoyuan City (TW); Chun-Wen WANG, Taoyuan City (TW); Chiung-Chang TSAI, Taoyuan City (TW); Ji-Dein WU, Taoyuan City (TW); Chun-Lung CHEN, Taoyuan City (TW); Chen-Hsiang LIN, Taoyuan City (TW)

(21) Appl. No.: 14/972,490

(22) Filed: Dec. 17, 2015

(51) Int. Cl. H04R 1/44; H04R 1/02

(52) U.S. Cl. CPC H04R 1/44; H04R 1/028; H04R 2499/15

(57) ABSTRACT

A waterproof electronic device that is waterproof and has pressure-equilibrium functions is provided. The waterproof electronic device includes a housing, a microphone, an elastic element, and a waterproof element. The housing has a chamber and an acoustic hole communicating with the chamber. The microphone is disposed in the chamber. The elastic element is disposed on the microphone. The elastic element includes a through hole facing the microphone, and a ventilation groove communicating with the through hole. The waterproof element is connected to the elastic element and the housing, and is configured to block liquid. The waterproof element includes pores communicating with the acoustic hole and the through hole.

### BACKGROUND OF THE INVENTION

Field of the Invention

The present disclosure relates to an electronic device, and in particular to a waterproof electronic device with pressure-equilibrium functions.

Description of the Related Art

According to trends in the development of portable electrical devices, smartwatches are becoming more and more important. These smartwatches can perform many features such as displaying the time, handling e-mail, providing communications, and playing games, while also being small and thin so as to allow their use without impairing their portability.

However, compared to smartphones and tablet computers, smartwatches are more likely to get splashed by water, since they are worn on the user's wrist. Accordingly, a highly waterproof property is required in order to allow the use of the smartwatch without malfunctioning when it gets wet.

Although existing smartwatches have generally been adequate for their intended purposes, they have not been entirely satisfactory in all respects. Consequently, it would be desirable to provide a solution for improving smartwatches.

### BRIEF SUMMARY OF THE INVENTION

The present disclosure provides a waterproof electronic device with pressure-equilibrium functions. The waterproof electronic device includes a housing, a microphone, an elastic element, and a waterproof element. The housing has a chamber and an acoustic hole communicating with the chamber. The microphone is disposed in the chamber. The elastic element is disposed on the microphone.

Moreover, the elastic element includes a through hole facing the microphone and a ventilation groove communicating with the through hole. The waterproof element is connected to the elastic element and the housing, and configured to block liquid. The waterproof element includes pores communicating with the acoustic hole and the through hole.

In some embodiments, the acoustic hole, the waterproof element, the through hole, and the microphone are arranged in sequence at an arrangement axis.

In some embodiments, the ventilation groove extends along an extension axis, which is perpendicular to the arrangement axis, and passes through the arrangement axis.

In some embodiments, the ventilation groove comprises varied widths, and the widths of the ventilation groove are gradually wider along the extension axis.

In some embodiments, the elastic element includes an elastic body and a seal protrusion. The elastic body is disposed on the microphone, and the seal protrusion is disposed on a front surface of the elastic body, abutting the waterproof element. The ventilation groove and the through hole are formed on the front surface.

In some embodiments, the elastic body includes a receiving groove that communicates with the through hole, and the microphone is located in the receiving groove.

In some embodiments, the waterproof electronic device also includes a processing module that is disposed in the chamber. The elastic element is located between a side wall of the housing and the processing module. The ventilation groove is closer to the processing module than the through hole.

In conclusion, liquid flowing into the acoustic hole is blocked from flowing into the chamber by the waterproof element. The sound outside of the waterproof electronic device can arrive at the microphone via the acoustic hole, the pores, and the through hole in sequence.

In addition, air in the chamber can flow out of the housing via the ventilation groove, the pores, and the acoustic hole in sequence when the pressure outside the housing is lower than the pressure in the chamber. Therefore, the pressure outside the housing and that inside the chamber are equilibrated, and the housing is not deformed when the waterproof electronic device is located in a low-pressure environment.

### BRIEF DESCRIPTION OF THE DRAWINGS

The invention can be more fully understood by reading the subsequent detailed description and examples with references made to the accompanying drawings, wherein:

FIG. 1 is a perspective view of a waterproof electronic device of the present disclosure;

FIG. 2 is an exploded view of the waterproof electronic device of the present disclosure;

FIG. 3 is a schematic view of the waterproof electronic device of the present disclosure; and

FIG. 4 is a perspective view of the elastic element of the present disclosure.

### DETAILED DESCRIPTION OF THE INVENTION

Specific examples of components and arrangements are described below to simplify the present disclosure. For example, the formation of a first feature over or on a second feature in the description that follows may include embodiments in which the first and second features are formed in direct contact, and may also include embodiments in which additional features may be formed between the first and second features, such that the first and second features may not be in direct contact.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The shape, size, and thickness in the drawings may not be drawn to scale, or the drawings may be otherwise simplified for clarity of discussion, as they are intended merely for illustration.

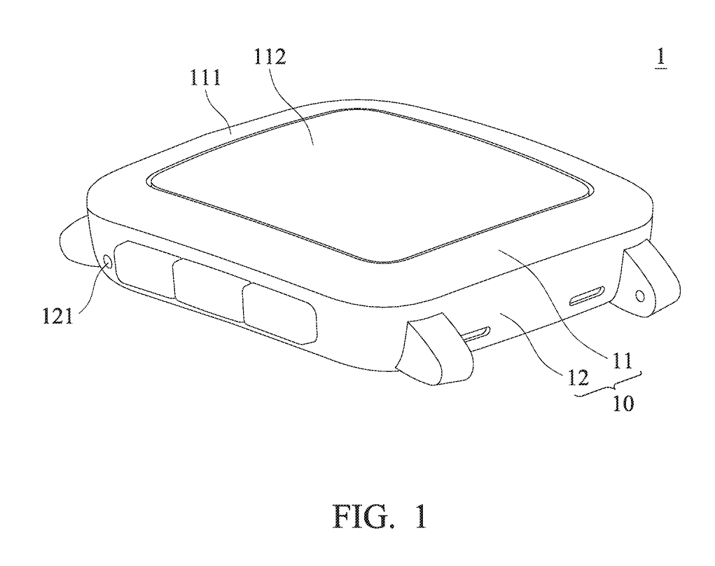

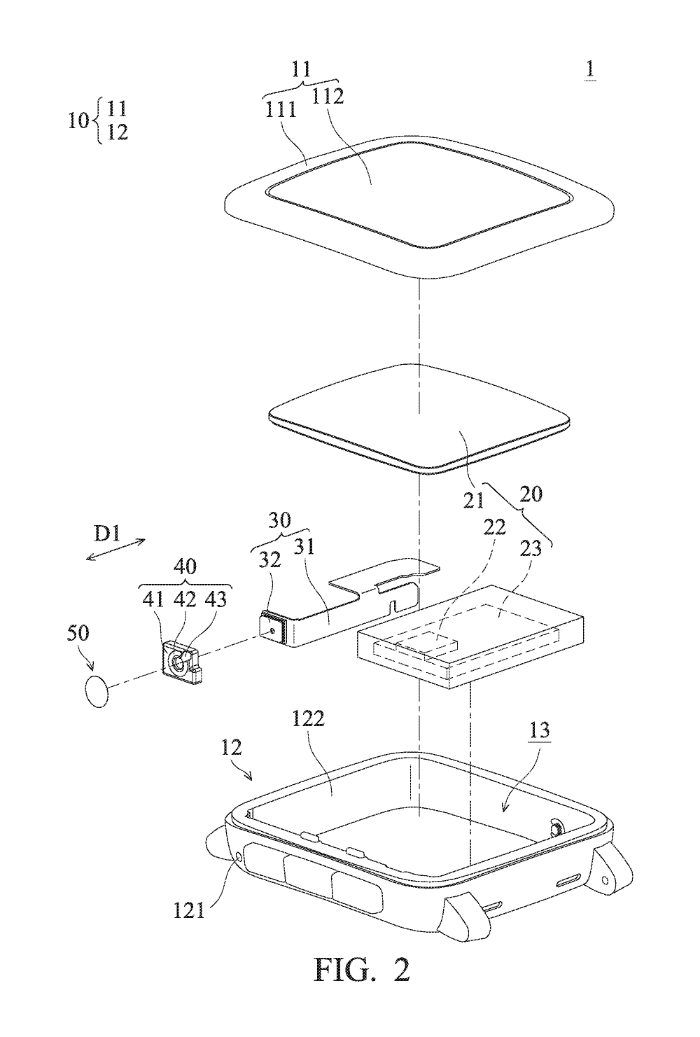

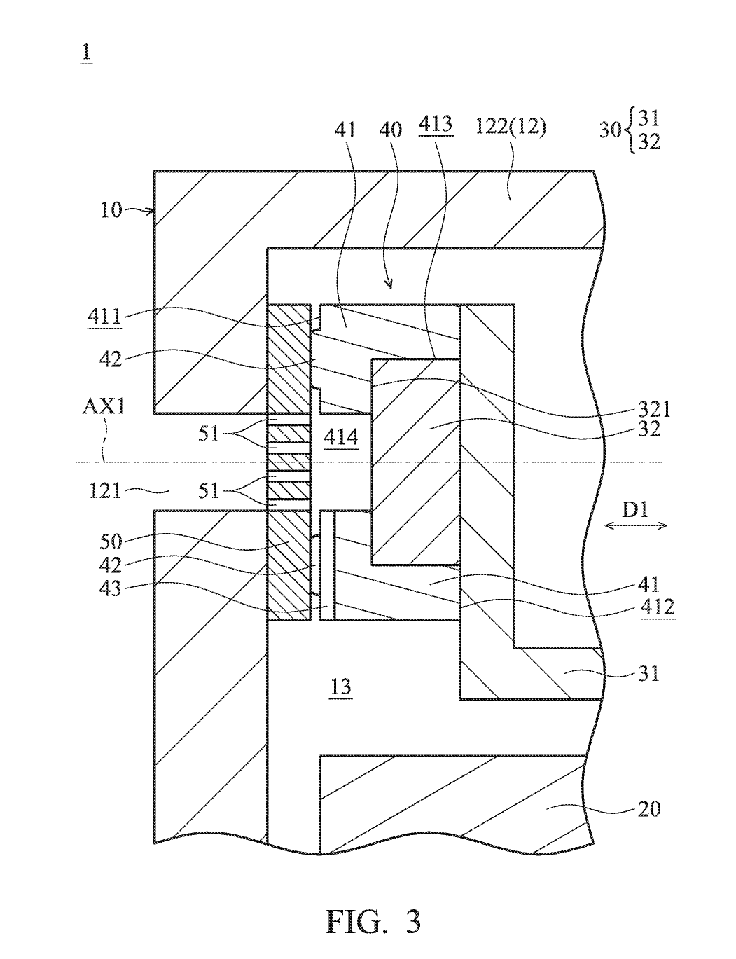

FIG. 1 is a perspective view of a waterproof electronic device 1 of the present disclosure. FIG. 2 is an exploded view of the waterproof electronic device 1 of the present disclosure. FIG. 3 is a schematic view of the waterproof electronic device 1 of the present disclosure. The waterproof electronic device 1 is waterproof and has pressure equilibrium functions. In some embodiments, the waterproof electronic device 1 is a portable waterproof electronic device. In some embodiments, the waterproof electronic device 1 is a smartwatch, a smartphone, or a tablet computer. In this embodiment, the waterproof electronic device 1 is a smartwatch, as shown in FIGS. 1 and 2.

The waterproof electronic device 1 includes a housing 10, a processing module 20, a microphone module 30, an elastic element 40, and a waterproof element 50. In some embodiments, the housing 10 includes a top housing 11, a bottom housing 12, and a chamber 13. The top housing 11 is disposed on the bottom housing 12. In some embodiments, the top housing 11 is fixed on the bottom housing 12.

In some embodiments, the top housing 11 is a plate structure. The top housing 11 includes a frame 111 and a transparent plate 112 connected to the frame 111. The transparent plate 112 is surrounded by the frame 111. In some embodiments, the frame 111 is made from metal or plastic. The transparent plate 112 is made from transparent material, such as glass.

The chamber 13 is formed when the top housing 11 is connected to the bottom housing 12. In other words, the chamber 13 is located between the top housing 11 and the bottom housing 12. The bottom housing 12 includes an acoustic hole 121 communicating with the chamber 13. As shown in FIG. 3, the acoustic hole 121, the waterproof element 50, the elastic element 40, and the microphone 32 are arranged in sequence at an arrangement axis AX1.

The processing module 20 is disposed in the chamber 13. In some embodiments, the processing module 20 includes a display panel 21 and a process chip 22, a printed circuit board 23. The display panel 21 faces and corresponds to the transparent plate 112. The process chip 22 is configured to control the display panel 21 to display images.

The display panel 21 and the process chip 22 are disposed on the printed circuit board 23. In this embodiment, the display panel 21 and the process chip 22 are electrically connected to the printed circuit board 23.

The microphone module 30 is disposed in the chamber 13, and located between a side wall 122 of the bottom housing 12 and the processing module 20. The microphone module 30 includes a rack 31 and a microphone 32. The rack 31 is located in the chamber 13. The rack 31 is configured to fix the microphone 32 on the housing 10.

The microphone 32 is disposed on the rack 31, and located in the chamber 13. In some embodiments, the microphone 32 is fixed on the rack 31. The microphone 32 corresponds to the acoustic hole 121 of the housing 10. The microphone 32 is electrically connected to the printed circuit board 23 of the processing module 20. The microphone 32 is configured to receive sound and generate sound signals to the processing module 20 according to the sound.

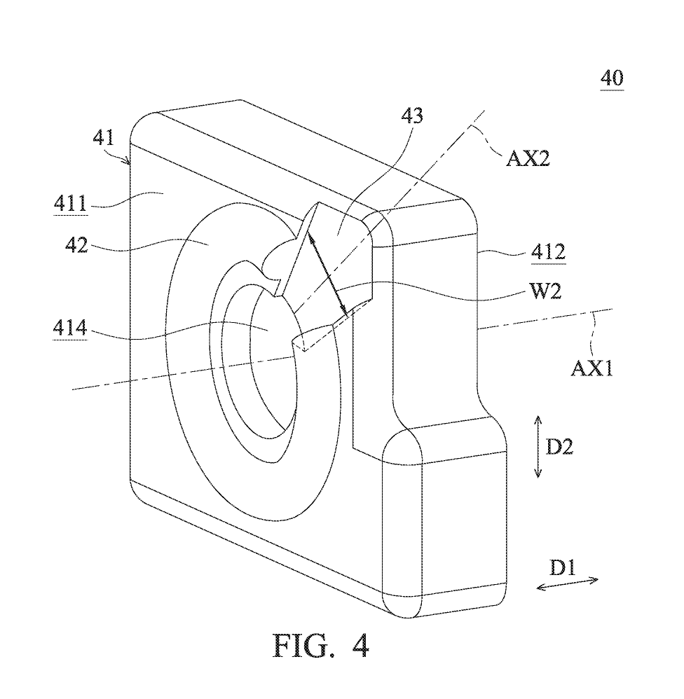

FIG. 4 is a perspective view of the elastic element 40 of the present disclosure. The elastic element 40 is disposed on the microphone 32, and located in the chamber 13. The elastic element 40 is located between the side wall 122 of the housing 10 and the processing module 20. In some embodiments, the elastic element 40 is made from rubber or elastoplastic.

The elastic element 40 includes an elastic body 41, a seal protrusion 42, and a ventilation groove 43. In some embodiments, the elastic body 41 and the seal protrusion 42 are formed as a single piece. The elastic body 41 and the seal protrusion 42 are made from the same material.

The elastic body 41 is disposed on the microphone 32. The elastic body 41 includes a front surface 411, a rear surface 412, a receiving groove 413, and a through hole 414. The front surface 411 is opposite to the rear surface 412. In some embodiments, the front surface 411 is parallel to the rear surface 412. The rear surface 412 is connected to the rack 31.

The receiving groove 413 forms on the rear surface 412. The receiving groove 413 is configured to receive the microphone 32. As shown in FIG. 3, the microphone 32 is located in the receiving groove 413. In some embodiments, the elastic body 41 is in contact with an acoustic surface 321 in the receiving groove 413.

The through hole 414 forms on the front surface 411. In some embodiments, the through hole 414 extends along the arrangement axis AX1. As shown in FIG. 3, the through hole 414 faces and corresponds to the microphone 32.

The seal protrusion 42 is disposed on the front surface 411 of the elastic body 41, abutting the waterproof element 50. The seal protrusion 42 is a ring-like structure adjacent to the through hole 414 at the front surface 411. As shown in FIG. 4, the seal protrusion 42 is surround the arrangement axis AX1 or the extension of the through hole 414.

The ventilation groove 43 forms on the front surface 411. As shown in FIGS. 3 and 4, the through hole 414 communicates with the receiving groove 413. In addition, the ventilation groove 43 extends along an extension axis AX2, and passes through the arrangement axis AX1. The extension axis AX2 is perpendicular to the arrangement axis AX1.

In some embodiments, the ventilation groove 43 forms on the seal protrusion 42 and extends to the elastic body 41. In other words, the ventilation groove 43 passes through the seal protrusion 42. As shown in FIG. 4, the seal protrusion 42 is a C-shaped structure. The seal protrusion 42 does not cover the ventilation groove 43 in an arrangement direction D1. The arrangement direction D1 is parallel to the arrangement axis AX1.

In a preferred embodiment, the ventilation groove 43 includes varied widths W2, and the widths W2 of the ventilation groove 43 is gradually wider along the extension axis AX2.

In general, any gaps between the elastic element 40 and the waterproof element 50 will cause the sound quality of the microphone 32 to decrease. However, thanks to the structures of the elastic element 40 and the ventilation groove 43 as described above, the decrease in microphone 32 sound quality caused by the ventilation groove 43 is minimal.

The waterproof element 50 is connected to the front surface 411 of the elastic element 40 and the housing 10. In other words, the waterproof element is located between the elastic element 40 and the housing 10. The waterproof element 50 is configured to block liquid, such as water.

In some embodiments, the waterproof element 50 is a membrane. The waterproof element 50 has a number of pores 51. The pores 51 communicate with the acoustic hole 121 and the through hole 414.

In some embodiments, the pore size of the pores 51 is smaller than 100 um. In some embodiments, the pore size of the pores 51 is in a range from 30 um to 90 um. Therefore, the pores 51 do not allow liquid, such as wafer, to pass through, and allow sound and air to pass through.

As shown in FIG. 3, when liquid flows into the acoustic hole 121, the liquid cannot pass through the pores 51, the liquid is blocked by the waterproof element 50, and thus the liquid cannot flow into the chamber 13. Therefore, the waterproof element 50 provides waterproof properties to the waterproof electronic device 1.

However, sound outside of the waterproof electronic device 1 can arrive at the microphone 32 via the acoustic hole 121, the pores 51, and the through hole 414 in sequence. Therefore, the microphone 32 can generate sound signals according to the sound.

In addition, air in the chamber 13 can flow out of the housing 10 via the ventilation groove 44, the pores 51, and the acoustic hole 121 in sequence when the pressure outside the housing 10 is lower than the pressure in the chamber 13. In the same way, air outside the housing 10 can flow into the chamber 13 via the acoustic hole 121, the pores 51, and the ventilation groove 44 in sequence when the pressure outside the housing 10 is higher than the pressure in the chamber 13.

Therefore, because of the structure of the ventilation groove 43 and elastic element 40, the pressure outside the housing 10 is equilibrated with the pressure inside the chamber 13, and the housing 10 is not deformed by the pressure difference outside the housing 10 and inside the chamber 13.

As shown in FIGS. 3 and 4, the ventilation groove 43 is closer to the processing module 20 than the through hole 414. Since the empty space around the processing module 20 is greater than the empty space between the side wall 122 and the microphone module 30. It is easier for air to flow through the ventilation groove 43.

In conclusion, liquid flowing into the acoustic hole is blocked from flowing into the chamber by the waterproof element. Moreover, the pressures outside the housing and inside the chamber are equilibrated by the structures of the elastic element and the ventilation groove.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A waterproof electronic device, comprising:
a housing having a chamber and an acoustic hole communicating with the chamber;
a microphone disposed in the chamber;
an elastic element, disposed on the microphone, comprising a through hole facing the microphone and a ventilation groove communicating with the through hole; and
a waterproof element, connected to the elastic element and the housing, configured to block liquid, wherein the waterproof element comprises a plurality of pores communicating with the acoustic hole and the through hole, and the pores allow sound and air to pass through, but not allow liquid to pass through,
wherein the acoustic hole, the waterproof element, the through hole, and the microphone are arranged in sequence at an arrangement axis, and the ventilation groove extends along an extension axis, which is perpendicular to the arrangement axis, and passes through the arrangement axis.

2-3. (canceled)

4. The waterproof electronic device as claimed in claim 1, wherein the ventilation groove comprises varied widths, and the widths of the ventilation groove is gradually wider along the extension axis.

5. The waterproof electronic device as claimed in claim 1, wherein the elastic element comprises:
an elastic body disposed on the microphone; and
a seal protrusion, disposed on a front surface of the elastic body, abutting the waterproof element,
wherein the ventilation groove and the through hole are formed on the front surface.

6. The waterproof electronic device as claimed in claim 5, wherein the elastic body comprises a receiving groove that communicates with the through hole, and the microphone is located in the receiving groove.

7. The waterproof electronic device as claimed in claim 1, further comprising a processing module disposed in the chamber, wherein the elastic element is located between a side wall of the housing and the processing module, and the ventilation groove is closer to the processing module than the through hole.

8. The waterproof electronic device as claimed in claim 1, wherein a pore size of the pores is in a range from 30 um to 90 um, and the pores allow sound and air to pass through.
